(19) United States
(12) Patent Application Publication
(10) Pub. No.: US 2024/0046640 A1
(43) Pub. Date: Feb. 8, 2024

(54) DATA PROCESSING METHOD, APPARATUS, AND SYSTEM FOR FIRE SCENE, AND UNMANNED AERIAL VEHICLE

(71) Applicant: SZ DJI TECHNOLOGY CO., LTD., Shenzhen (CN)

(72) Inventors: You ZHOU, Shenzhen (CN); Jifei XU, Shenzhen (CN); Weihang CHEN, Shenzhen (CN)

(21) Appl. No.: 18/488,541

(22) Filed: Oct. 17, 2023

Related U.S. Application Data
(63) Continuation of application No. PCT/CN2021/089659, filed on Apr. 25, 2021.

(51) Int. Cl. G06V 20/17; G06T 7/12; G06T 7/73; G06T 7/50; G06V 40/10; G06T 7/246; G08B 17/12; G01J 5/00; G01J 5/48

(52) U.S. Cl. CPC G06V 20/17; G06T 7/12; G06T 7/73; G06T 7/50; G06V 40/10; G06T 7/246; G08B 17/12; G01J 5/0025; G01J 5/0018; G01J 5/48; G06T 2207/10032; G06T 2207/10024; G06T 2207/20221; G06T 2207/10048; B64U 10/14

(57) ABSTRACT

A control method includes obtaining a thermal image of a fire area through an aerial vehicle, obtaining a temperature distribution of the fire area based on the thermal image, dividing the fire area into a plurality of sub-areas based on the temperature distribution of the fire area, and projecting the plurality of sub-areas on a map including the fire area displayed by a control terminal. The plurality of sub-areas have different fire levels.

### CROSS-REFERENCE TO RELATED APPLICATION

This application is a continuation of International Application No. PCT/CN2021/089659, filed Apr. 25, 2021, the entire content of which is incorporated herein by reference.

### TECHNICAL FIELD

The present disclosure relates to the unmanned aerial vehicle technology and, more particularly, to a data processing method, a data processing device, and a data processing system applied to a fire scene and an unmanned aerial vehicle.

### BACKGROUND

Fire is one of the most frequent and widespread major disasters that threaten public safety and development. Currently, unmanned aerial vehicles (UAVs) are used in fire scenes to capture images. Thus, firefighters extract information about the fire scene based on RGB images. However, due to a significant amount of smoke in the fire scenes, the smoke often blocks the image collection devices of the UAVs to reduce the accuracy of fire information extraction.

### SUMMARY

In accordance with the disclosure, there is provided a control method. The method includes obtaining a thermal image of a fire area through an aerial vehicle, obtaining a temperature distribution of the fire area based on the thermal image, dividing the fire area into a plurality of sub-areas based on the temperature distribution of the fire area, and projecting the plurality of sub-areas on a map including the fire area displayed by a control terminal. The plurality of sub-areas have different fire levels.

Also in accordance with the disclosure, there is provided a control device, including a processor. The processor is configured to obtain a thermal image of a fire area through an aerial vehicle, obtain a temperature distribution of the fire area based on the thermal image, divide the fire area into a plurality of sub-areas based on the temperature distribution of the fire area, and project the plurality of sub-areas on a map including the fire area displayed by a control terminal. The plurality of sub-areas have different fire levels.

### BRIEF DESCRIPTION OF THE DRAWINGS

FIG. 1 is a schematic flowchart of a data processing method for a fire scenario consistent with an embodiment of the present disclosure.

FIG. 2 is a schematic diagram of a projected map consistent with an embodiment of the present disclosure.

FIG. 3 is a schematic diagram showing a calculation method for a fire line moving speed consistent with an embodiment of the present disclosure.

FIG. 4 is a schematic diagram of a fire line segment consistent with an embodiment of the present disclosure.

FIG. 5A and FIG. 5B are schematic diagrams of warning information consistent with an embodiment of the present disclosure.

FIG. 6 is a schematic diagram of an early-warning map consistent with an embodiment of the present disclosure.

FIG. 7 is a schematic diagram showing a display method of an RGB image and an early-warning map of a fire area consistent with an embodiment of the present disclosure.

FIG. 8 is a schematic diagram of an image fusion method before and after fire consistent with an embodiment of the present disclosure.

FIG. 9 is a schematic interaction diagram of an aerial photography unmanned aerial vehicle and a rescue unmanned aerial vehicle consistent with an embodiment of the present disclosure.

FIG. 10A and FIG. 10B are schematic diagrams of a fire distribution map consistent with an embodiment of the present disclosure.

FIG. 11 is a schematic diagram of a data processing device applied to the fire scenario consistent with an embodiment of the present disclosure.

FIG. 12 is a schematic diagram of an unmanned aerial vehicle consistent with an embodiment of the present disclosure.

### DETAILED DESCRIPTION OF THE EMBODIMENTS

Embodiments of the present disclosure are described in detail and shown in the accompanying drawings. Unless otherwise specified, same numbers in different drawings represent same or similar elements. The embodiments described below do not represent all embodiments consistent with the present disclosure. On the contrary, the embodiments described below are merely some examples of devices and methods consistent with some aspects of the present disclosure as described in the appended claims.

The terminology used in the present disclosure is merely for the purpose of describing specific embodiments only and is not intended to limit the present disclosure. The singular forms “a,” “an,” and “the” are intended to include the plural forms unless the context clearly indicates otherwise. The term “and/or” refers to any one or more of the listed items and all possible combinations thereof.

Although the terms “first,” “second,” and “third,” are used to describe various information, the information should not be limited to these terms. These terms are only used to distinguish one type of information from another. For example, without departing from the scope of the present disclosure, first information can also be referred to as second information. Similarly, second information can also be referred to as first information, which depends on the context. For example, the term “if” used here can be explained as “when,” “upon,” or “in response to.”

When a fire occurs, an RGB image of the fire scene can be captured using a camera mounted on an aerial vehicle, e.g., an unmanned aerial vehicle (UAV). Then, fire scene information such as the position of the fire area and the fire line position can be extracted from the collected RGB image. However, due to a significant amount of smoke in the fire scene, the smoke can block the image collection device of the UAV, which reduces the accuracy of the fire information extraction.

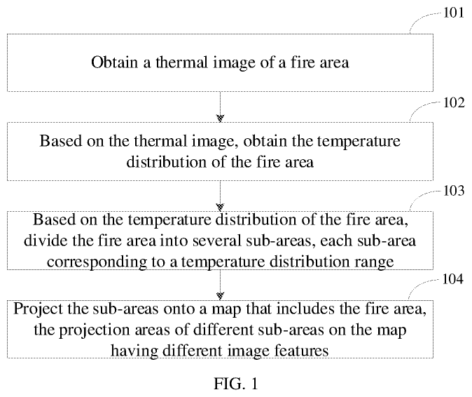

Based on this, embodiments of the present disclosure provide a data processing method for fire scenes. As shown in FIG. 1, the method includes the following processes.

At 101, a thermal image of a fire area is obtained.

At 102, based on the thermal image, the temperature distribution of the fire area is obtained.

At 103, based on the temperature distribution of the fire area, the fire area is divided into several sub-areas, and each sub-area corresponds to a temperature distribution range. The sub-areas can have different fire levels (i.e., different levels of severity of the fire).

At 104, the sub-areas are projected onto a map that includes the fire area, and the projection areas of different sub-areas on the map have different image features.

In embodiments of the present disclosure, based on the thermal image of the fire area, the sub-areas corresponding to different temperature distribution ranges can be displayed on the map of the fire area with different image features. Thus, fire information such as affected areas of the fire scene and fire conditions of the affected areas can be extracted. Since the thermal image is not affected by the smoke of the fire area, the accuracy of the fire information extraction can be improved.

In process 101, the fire area can include a burned area and an unburned area around the burned area. The burned area can include a burning area and a burned-out area. The unburned area can refer to an area where no-fire occurs. Focus only needs to be on the unburned area with a distance to the burned area smaller than a determined distance threshold (i.e., around the burned area). The distance threshold can be determined based on factors such as a fire spread speed, location and/or environment information of the burned area (e.g., a wind speed and rain/snow conditions). For example, when the fire spreads rapidly, the distance threshold can be set to a large value. When the fire spreads slowly, the distance threshold can be set to a small value. For example, if the burned area is located in a highly flammable or explosive area, an area prone to rapid fire spread (e.g., a gas station), or an area where toxic or harmful gases are easily generated and spread after ignition (e.g., a chemical factory), the distance threshold can be set to a large value. If the burned area is in an area where the fire is not easy to spread, such as a beach or a small island in the center of a river, and where toxic or harmful gases are not easily generated and spread after ignition, the distance threshold can be set to a small value. For example, when the wind speed is high, or the environment is dry, which causes the fire to be easy to spread, the distance threshold can be set to a large value. When the wind speed is small, or the environment is wet, and thus the fire is not easy to spread, the distance threshold can be set to a small value.

The UAV can carry a thermal imaging camera. A thermal image of the fire area can be collected by the thermal imaging camera. In some embodiments, the thermal imaging camera can be pre-positioned at a certain height to collect a thermal image of a specified area. Taking the UAV carrying the thermal imaging camera as an example, the UAV can be controlled to fly over the fire area to perform photography. After the UAV arrives at a position above the fire area, the flight direction of the UAV can be manually controlled, or the UAV can automatically cruise above the fire area to collect the thermal image of the fire area through the thermal imaging camera of the UAV. When the UAV automatically cruises, the UAV can adopt a predetermined cruising path, e.g., a circular cruising path, a zigzag cruising path, or an annular cruising path. In some other embodiments, the UAV can fly along a certain direction first, and after the fire line is detected, the UAV can fly along the fire line.

In process 102, the thermal image can be sent to the processor of the UAV to enable the processor to obtain the temperature distribution of the fire area based on the thermal image. The thermal image can also be sent to a control center or a control terminal (e.g., a cell phone or a remote controller) communicatively connected to the UAV. Thus, the control center or control terminal can obtain the temperature distribution of the fire area based on the thermal image.

In process 103, the fire area can be divided into several sub-areas, such as a no-fire area, a burning area, and a burned-out area based on the temperature distribution of the fire area. Different sub-areas can correspond to different temperature distribution ranges. For example, a sub-area with a temperature higher or equal to a first temperature threshold can be determined as a burning area. A sub-area with a temperature lower than the first temperature threshold and higher than or equal to a second temperature threshold can be determined as a burned-out area. A sub-area with a temperature lower than the second temperature threshold can be determined as a no-fire area. The first temperature threshold can be larger than the second temperature threshold.

Temperature change trends of the fire area can be obtained based on a plurality of thermal images collected at different times. The fire area can be divided into several sub-areas based on the temperature change trends. Different sub-areas can correspond to different temperature change trends. For example, the fire area can be divided into a temperature-rising sub-area, a temperature-lowering sub-area, and a temperature-maintaining sub-area.

Furthermore, the temperature distributions and the temperature change trends of the fire area can be obtained simultaneously. Based on the temperature distributions and the temperature change trends, the fire area can be divided into several sub-areas. Different sub-areas can correspond to different temperature distributions and/or temperature change trends. For example, a sub-area with a temperature not lower than the first threshold and continuously rising or being constant can be determined as a burning area. A sub-area with a temperature lower than the first threshold and not lower than the second temperature threshold or continuously lowering can be determined as a burned-out area. A sub-area with a temperature lower than the second temperature threshold can be determined as a no-fire area.

In process 104, boundary positions of the various sub-areas in physical space can be obtained from the thermal image. Based on the boundary positions, the sub-areas can be projected onto a map that includes the fire area. To distinguish the sub-areas, projection areas of different sub-areas on the map can correspond to different image features. The image feature can include at least one of a projection area color, a transparency, a filling pattern, a boundary line type of the projection area, or a boundary line color of the projection area.

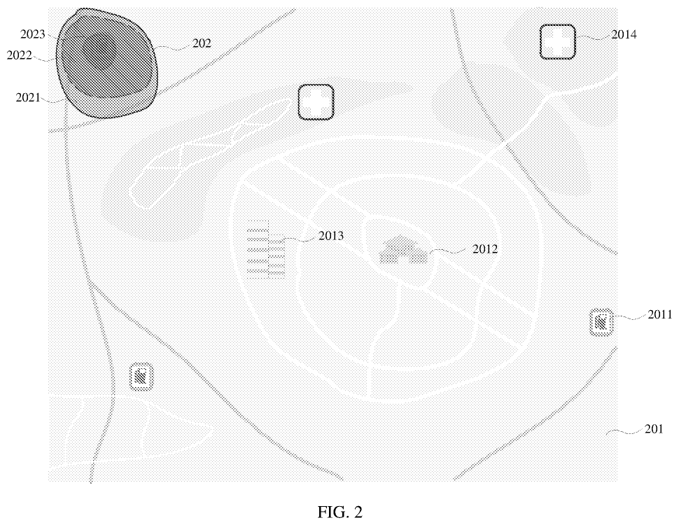

FIG. 2 illustrates a schematic diagram of a map 201 after projection consistent according to an embodiment of the present disclosure. The sub-areas in the fire area 202 are projected onto the map 201 to obtain the projected map. The fire area 202 includes a no-fire area 2021, which is represented in a first color with the boundary being a solid line on the map 201. The fire area 202 further includes a burning area 2022, which is presented in a second color with the boundary being a solid line and the filling pattern being a slash pattern on the map 201. The fire area 202 further includes a burned-out area 2023, which is represented in a third color with the boundary being a dashed line. In some embodiments, the sub-areas can further be represented in other image features, as long as the sub-areas can be distinguished, which is not limited here. In addition to the fire area 202, at least one target area can be represented on the map 201. The target area can include an area with a high population density, a flammable and explosive area, an area where the fire is prone to spread, an area with significant economic losses after the disaster, and an area prone to toxic and harmful gas leaks. In some embodiments, the target area includes at least one of a gas station 2011, a school 2012, a mall 2013, or a hospital 2014 shown in FIG. 2 and at least one of an amusement park, a zoo, a residential community, or a bank not shown in FIG. 2. The other target areas can include a target area in the fire area and a target area outside of the fire area. By displaying the sub-areas of the fire area and the target areas on the map 201, an area of the fire area, distances between the current fire area and the target areas, and target areas that can be affected by the fire can be directly represented. Thus, personnel evacuation, property transfer, and isolation and protection can be performed to further reduce human and property losses.

In some embodiments, boundaries of different sub-areas can be positioned in different positioning methods. Different positioning methods can correspond to different positioning accuracies. For example, the boundary between the burning area and the no-fire area can be determined in a first positioning strategy. The boundary between the burned-out area and the burning area can be determined in a second positioning strategy. The positioning accuracy using the second positioning strategy can be higher than the positioning accuracy of the second positioning strategy. In some embodiments, different positioning strategies can adopt different positioning methods. For example, the first positioning strategy can adopt at least one of a positioning method based on a Global positioning system (GPS), a positioning method based on vision, or a positioning method based on an inertial measurement unit (IMU). The second positioning strategy can adopt a fused positioning method, e.g., a fused positioning method based on GPS and IMU. In some embodiments, different calculation power and processing resources can be assigned to different positioning strategies. The boundary between the burned-out area and the burning area can be positioned through a positioning strategy with a high accuracy. On one aspect, the fire spread range can be accurately positioned, which facilitates the personnel evacuation, the property transfer, and the isolation protection. while reducing data processing volume. On another aspect, the data processing amount can be reduced.

Since the fire spreads outwardly, the positions of the fire area and/or some or all of sub-areas can be updated in real-time on the map of the fire area to know the fire dynamic state. For example, a thermal image of the fire area can be obtained in real-time at a certain frequency. The sub-areas of the fire area can be updated based on the thermal image collected in real-time. The updated sub-areas can be projected onto the map including the fire area to display the positions of the sub-areas of the fire area on the map of the fire area. The target image (including a thermal image and/or an RGB image) of the fire area can be obtained in real-time. The position of the fire line (the boundary between the burned area and the unburned area) can be extracted from the obtained target image. The position of the fire area can be updated based on the position of the fire line, and the updated fire area can be projected onto the map including the fire area to display the position of the fire area on the map of the fire area.

For a thermal image, a target pixel with a temperature not lower than the first temperature threshold can be extracted from the thermal image and determined as a pixel on the fire line. For an RGB image, the pixel on the fire line can be extracted in a boundary detection method. The pixel on the fire line can also be determined in connection with the thermal image and the RGB image. The target pixel can be collected by the image collection device (e.g., an infrared thermal imager and a camera) of the UAV or by an image collection device that is pre-set at a certain height. For example, the image collection device carried by the UAV can be configured to collect the RGB image. Then, the depth information of the pixel of the fire line can be obtained. The position information of the pixel of the fire line can be determined based on the attitude of the image collection device, the pose of the UAV when collecting the RGB image, and the depth information of the pixel of the fire line. The depth information of the pixel of the fire line can be determined based on RGB images collected when the UAV has different poses. When the image collection device is a binocular camera, the depth information of the pixel of the fire line can also be determined based on binocular disparity.

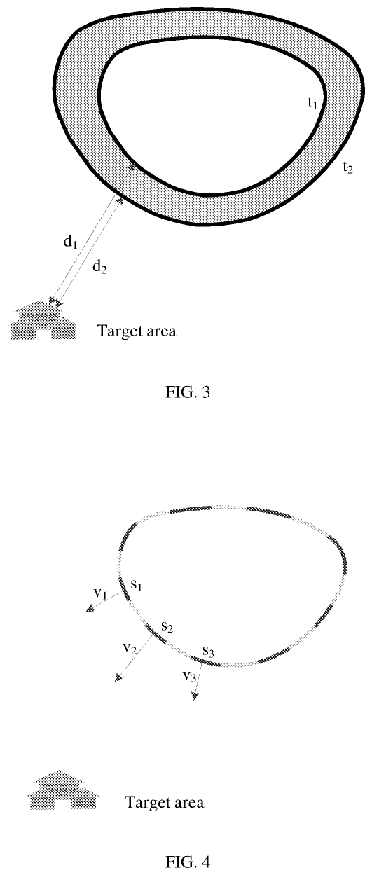

After the position information of the fire line is determined, the position information of the target area can be extracted from the map based on the position information of the fire line, and the distance between the fire line and the target area can be determined. The time for the fire line to move to the target area can be predicted based on the moving speed of the fire line and the distance between the fire line and the target area. The moving speed of the fire line can be calculated based on a distance difference between the fire line and the target area within a certain period. As shown in FIG. 3, assume that the distance between the fire line and the target area is d₁ at time t₁, and the distance between the fire line and the target area is d₁ at time t₂, the moving speed of the fire line is calculated by the following formula:

v=|d₁−d₂|/|t₁−t₂| (1)

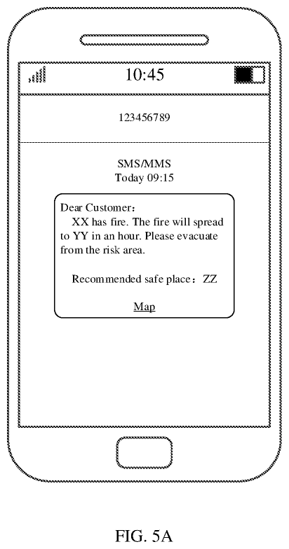

To determine the moving speed of the fire line more accurately, the fire line can be divided into a plurality of segments to obtain moving speed information for each fire line segment separately. The fire line can be divided into segments based on the orientations of the fire line segments. For example, the fire line between the east direction and south direction can be divided as a fire line segment, the fire line between the south direction and the west direction can be divided as a fire line segment, the fire line between the west direction and the north direction can be divided as a fire line segment, and the fire line between the north direction and the east direction can be divided as a fire line segment. In some embodiments, the fire line can also be divided into more shorter segments. Normal vectors of the fire line segments can be determined as the orientations of the fire line segments. As shown in FIG. 4, the fire line includes fire line segments s1, s2, and s3 with different orientations. Moving speeds of fire line segments s1, s2, and s3 can be calculated, respectively, and denoted as v1, v2, and v3. A moving speed of a fire line segment can be determined based on the formula (1).

The moving speed of the fire line segment can be different under different conditions. The moving speed can be affected by factors such as the orientation of the fire line segment, environmental factors, the topography of the fire area, the type of the fire area, and the type of the area surrounding the fire area. The environmental factors may include at least one of wind speed, wind direction, environmental temperature, environmental humidity, or weather. The topography of the fire area can include open flat terrain, canyon, and valley. The type of the fire area can include flammable and explosive areas, areas where the fire can easily spread, and areas where toxic and harmful gases can easily be generated and spread after ignition. For example, a moving speed of a fire line segment with an orientation the same as the wind direction can be faster than a moving speed of a fire line segment with an orientation different from the wind direction. The moving speed of a fire line segment can be higher when the environmental humidity is lower than when the environmental humidity is higher. The moving speed of a fire line segment can be higher in a canyon than on open flat terrain. Therefore, the moving speed of the fire line segment can be corrected based on at least one target information, such as an angle between the normal vector of the fire line segment and the wind direction, the topography of the fire area, the type of the fire area, the type of the area surrounding the fire area, and the environmental information.

In some embodiments, a risk level of the target area can also be determined to determine the measures to be taken for personnel evacuation, property transfer, and isolation protection in the target area. The risk level of the target area can be determined based on any one of the time for the fire line to move to the target area, the time for the fire line to move to the target area and the type of the target area, and the time for the fire line to move to the target area and the moving speed and the moving direction of the target gas in the fire area.

The time for the fire line to move to the target area can be an absolute time, such as 19:00, or a time interval between a predicted time the fire line arrives at the target area and the current time, for example, one hour later. The smaller the time interval between the time for the fire line to move to the target area and the current time is, the higher the risk level of the target area is. On the contrary, the larger the time interval between the time for the fire line to move to the target area and the current time is, the smaller the risk level of the target area is. When the type of the target area is a flammable and explosive area, an area where the fire can easily spread, and an area where toxic and harmful gases are easily generated and spread after ignition, the risk level of the target area can be high. When the type of the target area is an open plain area without people, an area where the fire is not easily spread, and an area where toxic and harmful gases are not easily generated and spread after ignition, the risk level of the target area can be lower. When the moving speed of the target gas in the fire area is fast, the risk level of the target area in the moving direction of the target gas can be high, and the risk levels of other target areas that are not in the moving direction of the target gas can be low. The target gas can include toxic and harmful gases such as carbon monoxide, hydrogen cyanide, and so on.

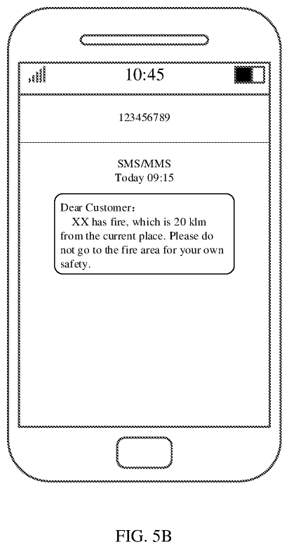

Same or different pieces of alarm information can be broadcast to different target areas. For example, alarm information can be broadcast to target areas based on the risk levels of the target areas. Different pieces of alarm information can be broadcast for target areas with different risk levels. For example, the alarm information can be broadcast only to a target area with a risk level greater than a preset value. The alarm information can be determined based on at least one of the position of the target area, the position of the fire area, the moving speed of the fire line, and the moving direction of the fire line. The alarm information can include but is not limited to SMS, voice, or images. As shown in FIG. 5A, for the target area with the high-risk level, the broadcast information (e.g., SMS information) sent to these target areas can carry information such as the position of the fire area, the predicted time information for the fire area to arrive at the current location, the address information of recommended safe location, and the navigation information between the current location and the safe location. The broadcast information can include interfaces for calling the map software. By calling the map software, information about the recommended safe location and the navigation information between the current location and the safe location can be searched for. As shown in FIG. 5B, for the target area with the low-risk level, the broadcast information sent to the target area can only include the position of the fire area, the distance between the fire area and the current location, and warning information, for example, “Please don't go to the fire area for your safety.”

In some embodiments, the power can also be cut off in a designated area. The designated area can be determined according to the position information of the fire area. For example, the designated area can be the risk area having a distance to the fire smaller than the preset distance threshold. A control instruction can be sent to the power station of the risk area to disconnect the power supply of the power station of the risk area for the whole risk area. In some other embodiments, the control instruction can also be sent to the power control apparatus that establishes the communicative connection in advance in the risk area to cause the power control apparatus to switch to a target status. In the target status, the power of the risk area can be disconnected. Thus, the power can be partially disconnected for the risk area on purpose. The control instruction can also be sent to other apparatuses that establish the communicative connection in advance in the risk area to cause the other apparatuses to switch to the target operation status. For example, the other apparatuses can include electric fire shutter doors. The electric fire shutter doors can be controlled to close by sending a close instruction to the electric fire shutter doors. For another example, the other apparatuses can be alarms. The alarms can be controlled to be activated to issue the alarms by sending the activation instructions to the alarms.

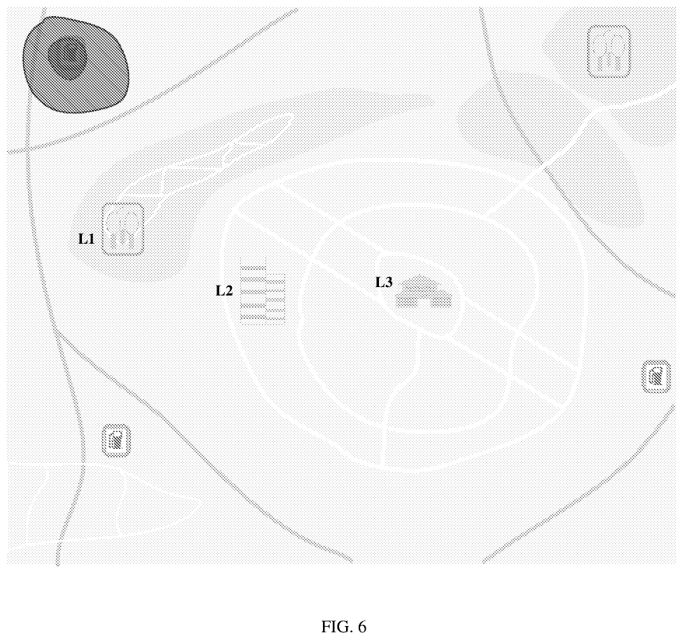

After the risk levels of the target areas surrounding the fire area are determined, a warning map of the fire area can be created. The warning map of the fire area can be used to represent the risk levels of the target areas surrounding the fire area. The target areas with different risk levels can be marked with different attributes (such as colors, shapes, characters, etc.) on the warning map to facilitate direct viewing of the risk levels of the target area. As shown in FIG. 6, word information (e.g., L1, L2, and L3) used to represent the risk levels are added to the target areas on the map to generate the warning map. L1, L2, and L3 can represent decreasing risk levels.

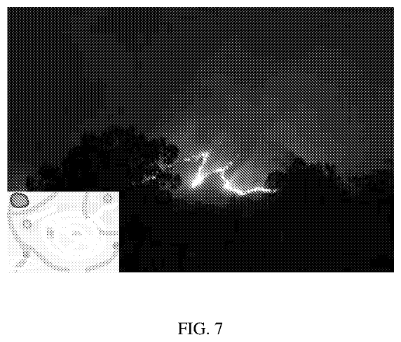

The warning map can be updated in real-time based on information such as the position and the moving speed of the fire line. Furthermore, the RGB image and the warning map of the fire area can be displayed. For example, the warning map can be displayed at a predetermined position of the RGB image. The predetermined position can include areas such as the lower left corner of the RGB image (as shown in FIG. 7) and the upper right corner. In some other embodiments, the warning map can be combined with the RGB image, and then the combined image can be displayed. In some other embodiments, the warning map and RGB image can be alternately displayed or jointly displayed in other methods, which are not limited here.

In some embodiments, a disaster level of the fire can also be determined based on the area of the fire area. The disaster level can be positively correlated with the area of the fire area. That is, the larger the area of the fire area is, the higher the disaster level is. Thus, the disaster situation is more severe. The disaster level of the fire can be determined after the fire has ended or in real-time during the occurrence of the fire. The area of the fire area can be calculated based on the area enclosed by the fire lines detected from the RGB image or based on the area of the area with a temperature higher than a preset value in the thermal image.

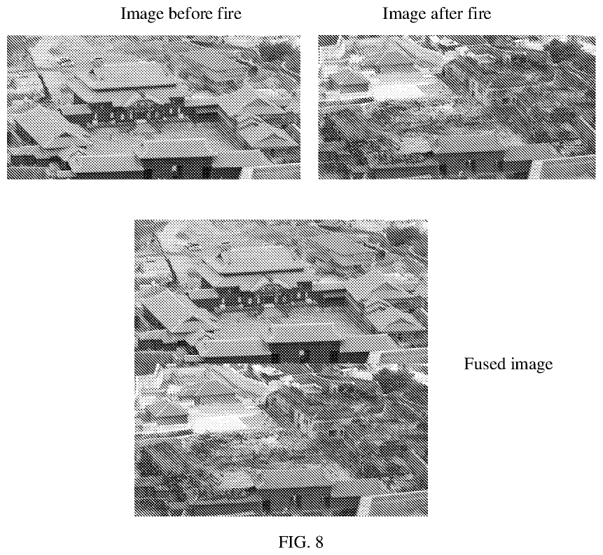

In some embodiments, images before and after the fire can also be fused for the same area to determine the losses caused by the fire. In some embodiments, a first image of the fire area before the fire starts can be obtained. The first image can be collected by the image collection device of the UAV in a first pose. The UAV can be controlled to collect a second image of the fire image in the first attitude after the fire. The first image and the second image can be fused to obtain a fusion image. The fusion image can be a static image as shown in FIG. 8, or a static image or motion image fused in other methods. By controlling the UAV to collect the two images at the same pose before and after the fire, the situations before and after the fire can be compared to determine the losses caused by the fire. The first image and the second image can be the RGB images. In addition to the fusion method, the losses caused by the fire can also be determined by fusing remote sensing images before and after the fire.

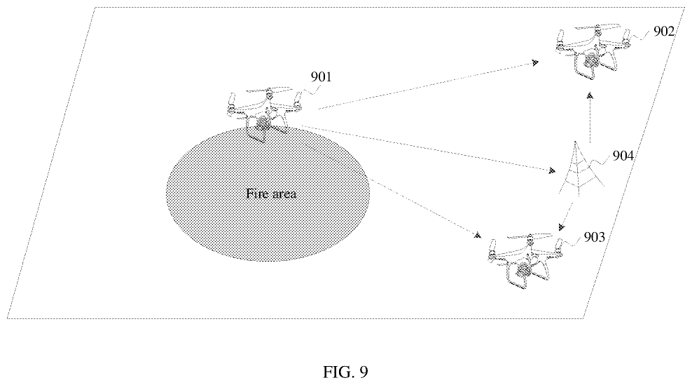

In some embodiments, position information and environment information of the fire area can be obtained. The position information and the environment information of the fire area can be sent to a rescue UAV, so that the rescue UAV can transport rescue supplies to the fire area. The position information of the fire area can include the position information of the fire line and the area of the burning area. The environment information can include wind speed, wind direction, environment humidity, environment temperature, and the position information of water sources around the fire area. As shown in FIG. 9, target images of the fire area (e.g., thermal images and/or RGB images) are obtained by the image collection device, such as the thermal imagers and the visual sensors carried by the aerial photography UAV 901. The UAV 901 can fly over the fire area to collect the target images of the fire area (e.g., the thermal images and/or RGB images). The position information of the fire area can be obtained based on the target images). The aerial photography UAV 901 can also carry the sensor configured to detect environmental information, such as the temperature sensor, a humidity sensor, and a wind speed sensor, to obtain the environment information. The aerial photography UAV 901 can directly send the position information and the environment information of the fire area to a rescue UAV 902 and a rescue UAV 903. In some other embodiments, the aerial photography UAV 901 can send the position information and the environment information to the rescue UAV 902 and the rescue UAV 903 through a control center 904.

In some embodiments, a fire distribution map can be obtained based on fire information. The fire distribution map can be used to represent the frequency and scale of fires in different areas during different time periods. The fire information can include the position of the fire area, the range of the burning area, and at least one of the occurrence time or the duration of the fire. For example, markers can be generated on the map based on the position information of the fire area at corresponding positions on the map. One marker can correspond to one fire. The attribute can include size, color, shape, etc., and moreover, a chart (e.g., a bar chart, a line chart, a pie chart, etc.) of the number of times of the fire occurrences over time.

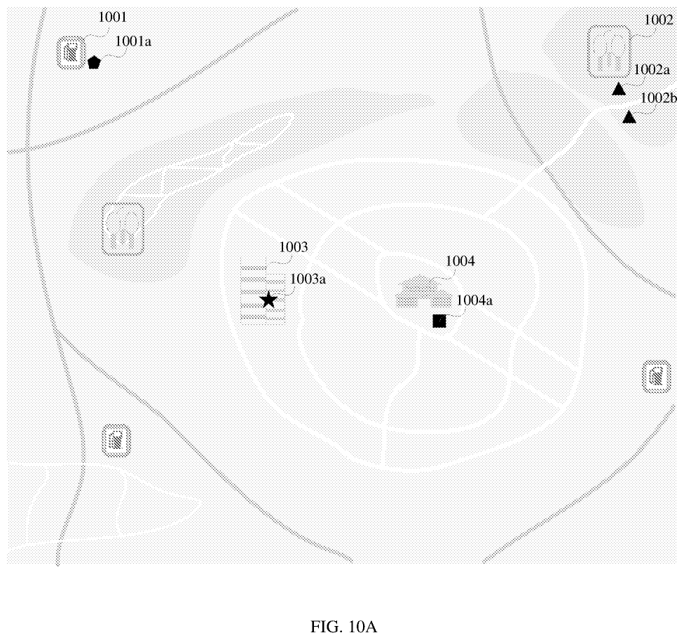

FIG. 10A is a schematic diagram showing the fire occurrence in different target areas within a statistical time period (e.g., 1 year, 6 months, 1 month, etc.). Markers of a pentagon 1001a, triangles 1002a and 1002b, a pentagram 1003a, and a quadrilateral 1004a are used to represent fire occurrences. The position of the marker on the map can be used to represent the position of the fire occurrence. For example, the pentagon marker 1001a can be near a gas station 1001, indicating that the fire is near the gas station 1001. The markers of triangles 1002a and 1002b can be near a park 1002, indicating that the fires are near the park 1002. Similarly, Markers of the pentagram 1003a and quadrilateral 1004a can be used to represent the fires near a mall 1003 and a school 1004, respectively. The number of markers around the same target area can be used to represent the number of times of fire occurrences around that target area. For example, the gas station 1001, mall 1003, and school 1004 can each include one marker, indicating that one fire occurs at each of the gas station 1001, the mall 1003, and the school 1004 within the time period. Two markers 1002a and 1002b are near the park 1002, which indicates that the two fires occur near the park 1002 within the time period.

As shown in FIG. 10B, the time period is further divided into a plurality of sub-intervals. For example, the time period can be a half year. Each month can be a sub-area. The number of times of fire occurrences can be counted in each sub-area separately to generate a bar chart.

In some embodiments, a living body can be searched for in the fire area based on the thermal image of the fire area. If the living body is found, the position information of the living body can be obtained, and the position information can be sent to the target apparatus. The living body can include at least one of people and animal. The target apparatus can include but is not limited to a rescue UAV. The target apparatus can include, but is not limited to, a rescue UAV, a terminal apparatus of a rescue personnel, or a control center. By searching for the living body based on the thermal image, the living body can be rescued in the fire area in time to improve the safety of the life and property. The thermal image can be collected by the thermal imaging apparatus carried by a movable platform, such as a UAV or a movable robot. The movable platform can be configured to obtain the position information of the living body in the global coordinate system or the position information in the coordinate system of the movable platform. Further, the position information of the living body in the global coordinate system or the position information of the living body in the coordinate system of the movable platform can be converted into the position information of the living body in a local coordinate system. For example, in an indoor scene, the position information of the living body in the global coordinate system and the position information of the living body in the coordinate system of the movable platform can be converted into the position information of the living body in the local coordinate system of the indoor area. Then, the position information can be sent to the target apparatus.

Those skilled in the art can understand that in embodiments of the present disclosure, a sequence of the processes described here does not mean that the processes need to be performed according to the sequence and does not limit the present disclosure. The sequence in which the processes are performed can be determined according to the functions and the internal logic of the processes.

Embodiments of the present disclosure also provide a data processing device applied to a fire scene, including a processor. The processor can be configured to obtain the thermal image of the fire area, obtain the temperature distribution of the fire area based on the thermal image, divide the fire area into several sub-areas based on the temperature distribution of the fire area, each sub-area corresponding to a temperature distribution interval, and project the sub-areas onto a map that includes the fire area, the projection areas of different sub-areas corresponding to different image features.

In some embodiments, the image feature can include at least one of color, transparency, filling pattern of the projected area, the line type of the boundary of the projected area, or the line color of the boundary of the projected area.

In some embodiments, the several sub-areas can include a no-fire area, a burning area, and a burned-out area.

In some embodiments, the processor can be further configured to determine the boundary between the burning area and the no-fire area using a first positioning strategy and determine the boundary between the burned-out area and the burning area using a second positioning strategy. The positioning accuracy of the first positioning strategy can be higher than the positioning accuracy of the second positioning strategy.

In some embodiments, the processor can be further configured to obtain the position information of the fire line of the fire area in real-time, projecting the image of the fire area onto the map of the fire area based on the position information of the fire line to display the position of the fire area on the map of the fire area, and determining the distance between the fire area and the target area based on the position of the fire area and the position information of the target area. The map of the fire area can include at least one position information of the target area.

In some embodiments, the processor can be further configured to obtain moving speed information of the fire line and predict the time for the fire line to move to the target area based on the distance between the fire area and the target area and the moving speed information of the fire line.

In some embodiments, the target area can include at least one of a school, a gas station, a hospital, a power station, a chemical plant, and an area with a population density greater than a preset value.

In some embodiments, the processor can be further configured to determine the risk level of the target area based on one of the time for the fire line to move to the target area, the time for the fire line to move to the target area and the type of the target area, and the time for the fire line to move to the target area and the moving speed and direction of the target gas in the fire area.

In some embodiments, the processor can be further configured to broadcast alarm information to a target area with a risk level greater than a preset value.

In some embodiments, the alarm information can include information about an evacuation route from the target area to a safe area or the address information of the safe area.

In some embodiments, the alarm information can be determined based on the position of the target area, the position of the fire area, the moving speed of the fire line, and the moving direction of the fire line.

In some embodiments, the processor can be further configured to divide the fire line into a plurality of line segments and obtain the moving speed information for each fire line segment.

In some embodiments, the processor can be configured to obtain the moving speed information of the fire line segment based on the target information. The target information can include at least one of the angle between the normal vector of the fire line segment and the wind direction, the terrain of the fire area, the type of the area around the fire area, and the environment information.

In some embodiments, the processor can be further configured to obtain the RGB image of the fire area and detect the position information of the fire line from the RGB image of the fire area.

In some embodiments, the RGB image can be collected by the image collection device at the UAV. The processor can be configured to determine the depth information of the pixel at the fire line based on the RGB image collected when the UAVs at different attitudes and determine the position information of the pixel at the fire line based on the attitude of the image collection device, the attitude of the UAV when collecting the RGB image, and the depth information of the pixel at the fire line.

In some embodiments, the processor can be further configured to determine the disaster level of the fire based on the area of the fire area. The disaster level can be positively correlated to the area of the fire area.

In some embodiments, the processor can be further configured to obtain the position information of the fire area, based on the position information of the fire area, determine the risk area around the fire area, and control the power of the risk area to be disconnected. The distance between the risk area and the fire area can be shorter than a preset distance threshold.

In some embodiments, the processor can be configured to send the control instruction to the power station of the risk area to cause the power station of the risk area to disconnect the power to the risk area, or send the control instruction to the power control apparatus that establishes the communicative connection in advance to cause the power control apparatus to switch to the target status. The target status can be used to cause the power to be disconnected in the risk area.

In some embodiments, the processor can be further configured to obtain the first image of the fire area before the fire starts, control the UAV to collect the second image of the fire area in the first pose after the fire starts, and fuse the first image and the second image to obtain a fused image. The first image can be collected by the image collection device of the UAV in the first pose.

In some embodiments, the processor can be further configured to obtain the RGB image of the fire area and a warning map of the fire area and display the RGB image and the warning map. The warning map of the fire area can be used to represent the risk levels of the target areas around the fire area. The warning map can be displayed at a predetermined position of the RGB image.

In some embodiments, the processor can be further configured to obtain the position information and the environment information of the fire area and send the position information and the environment information of the fire area to the rescue UAV.

In some embodiments, the processor can be further configured to obtain the information of the fire, including the position of the fire area, the range of the burning area, and the occurrence time and duration of the fire, and generate the fire distribution map based on the fire information. The fire distribution map can be used to represent the frequency and scale of the fires in different areas during different time periods.

In some embodiments, the processor can be further configured to search for a living body in the fire area based on the thermal image of the fire area, if the living body is found, obtain the position information of the living body, and send the position information to the target apparatus.

In some embodiments, the thermal image can be collected by the thermal imaging apparatus of the UAV. The fire area can be an indoor area. The processor can be further configured to obtain the position information of the living body in the UAV coordinate system, convert the position information of the living body in the UAV coordinate system into the position information of the living body in the local coordinate system of the indoor area, and send the position information to the target apparatus. That is, the position information of the living body in the local coordinate system of the indoor area can be sent to the target apparatus.

In embodiments of the present disclosure, for the methods performed by the processor of the data processing device applied in the fire scene, reference can be made to the above method embodiments, which are not repeated here.

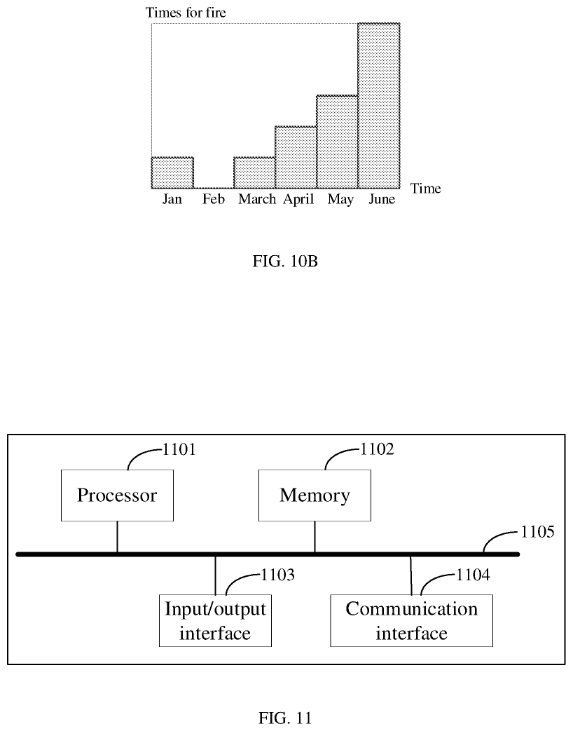

FIG. 11 is a schematic diagram of a data processing device applied in the fire scene consistent with an embodiment of the present disclosure. The device includes a processor 1101, a memory 1102, an input/output interface 1103, a communication interface 1104, and a bus 1105. The processor 1101, the memory 1102, the input/output interface 1103, and the communication interface 1104 can be communicatively connected to each other inside the device through the bus 1105.

The processor 1101 can include a general-purpose central processing unit (CPU), a microprocessor, an application-specific integrated circuit (ASIC), or one or more integrated circuits. The processor 1101 can be configured to execute a relevant program to implement the technical solution of embodiments of the present disclosure.

The memory 1102 can include a read-only memory (ROM), a random access memory (RAM), a static storage device, a dynamic storage device, etc. The memory 1102 can be used to store an operating system and other applications. When the technical solutions of embodiments of the present disclosure are implemented through software or firmware, relevant program codes can be stored in the memory 1102 and executed by the processor 1101.

The input/output interface 1103 can be configured to be connected to an input/output module to input and output the information. The input/output module can be configured as a component within the device (not shown in the figure) or can be external to the device to provide a corresponding function. The input apparatus can include a keyboard, a mouse, a touchscreen, a microphone, various sensors, etc., and the output apparatus can include a display, a speaker, a vibrator, an indicator, etc.

The communication interface 1104 can be configured to be connected to a communication module (not shown in the figure) to enable communication and interaction between the device and other devices. The communication module can implement communication in a wired manner (such as USB, cable, etc.) or a wireless manner (such as mobile networks, Wi-Fi, Bluetooth, etc.).

The bus 1105 can include a pathway configured to transmit information between various components of the device (e.g., the processor 1101, the memory 1102, the input/output interface 1103, and the communication interface 1104).

Although only the processor 1101, the memory 1102, the input/output interface 1103, the communication interface 1104, and the bus 1105 are shown in the device above, the device can also include other components necessary for a normal operation. Moreover, those skilled in the art can understand that the above device may only include components necessary for implementing embodiments of the present disclosure and may not necessarily include all the components shown in the figure.

Embodiments of the present disclosure further provide a UAV. The UAV can include a power system, a flight control system, a thermal imaging apparatus, and a processor.

The power system can be configured to provide power to the UAV. The flight control system can be configured to control the UAV to fly over the fire area. The thermal imaging apparatus can be configured to obtain the thermal image of the fire area. The processor can be configured to obtain the temperature distribution of the fire area based on the thermal image, divide the fire area into several sub-areas based on the temperature distribution of the fire area, and project the sub-areas onto the map including the fire area. Each sub-area can correspond to a temperature distribution range. The projection areas of different sub-areas on the map can correspond to different image features.

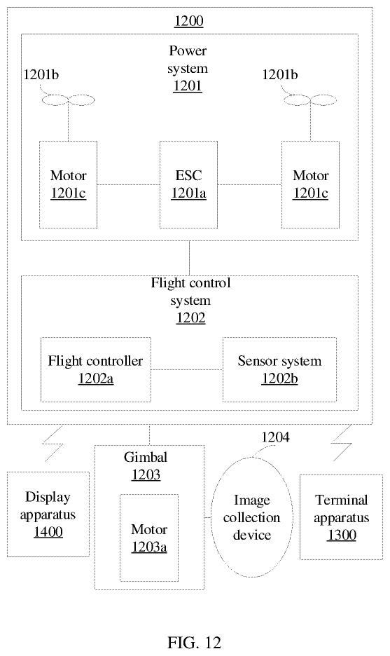

FIG. 12 is a schematic diagram of a UAV 1200 consistent with an embodiment of the present disclosure. For example, the UAV can be a rotary-wing UAV.

The UAV 1200 includes a power system 1201, a flight control system 1202, a frame, and a gimbal 1203 carried by the frame. The UAV 1200 can communicate wirelessly with a terminal apparatus 1300 and a display apparatus 1400.

The power system 1201 includes one or more electronic speed controllers (i.e., ESCs) 1201a, one or more propellers 1201b, and one or more motors 1201c corresponding to the one or more propellers 1201b. A motor 1201c is connected between an ESC 1201a and a propeller 1201b. The motor 1201c and the propeller 1201b are arranged at an arm of the UAV 1200. The ESC 1201a can be configured to receive a drive signal generated by the flight control system 1202 and provide a drive current to the motor 1201c according to the drive signal to control the rotation speed of the motor 1201c. The motor 1201c can be configured to drive the propeller to rotate to provide power for the flight of the UAV 1200. The power can be used to enable the UAV 1200 to realize the movement of one or more degrees of freedom. In some embodiments, the UAV 1200 can rotate around one or more rotation axes. For example, the above rotation axes can include a roll axis, a yaw axis, and a pitch axis. The motor 1201c can be a direct current (DC) motor or an alternating current (AC) motor. In addition, the motor 1201c can be a brushless motor or a brushed motor.

The flight control system 1202 includes a flight controller 1202a (i.g., the flight control device) and a sensor system 1202b. The sensor system 1202b can be configured to measure the attitude information of the UAV, i.e., the position information and the status information of the UAV 1200 in space, e.g., a 3D position, a 3D angle, a 3D speed, a 3D acceleration, and a 3D angular speed. The sensor system 1202b can include a gyroscope, an ultrasonic sensor, an electronic compass, an inertial measurement unit, a vision sensor, a global navigation satellite system, a temperature sensor, a humidity sensor, a wind speed sensor, and a barometer. For example, the global navigation satellite system can be a global positioning system. The flight controller 1202a can be configured to control the flight of the UAV 1200. For example, the flight of the UAV 1200 can be controlled according to the attitude information measured by the sensor system 1202b. The flight controller 1202a can be configured to control the UAV 1200 according to a pre-programmed instruction, or the UAV 1200 can be controlled by the one or more remote signals from the terminal apparatus 1300.

The gimbal 1203 includes a motor 1203a. The gimbal can be configured to carry an image collection device 1204. The flight controller 1202a can be configured to control the movement of the gimbal 1203 through the motor 1203a. In some embodiments, the gimbal 1203 can also include a controller configured to control the movement of the gimbal 1203 through the motor 1203a. The gimbal 1203 can be independent of the UAV 1200 or can be a part of the UAV 1200. The motor 1203a can be a direct current (DC) motor or an alternating current (AC) motor. In addition, the motor 1203a can be a brushless motor or a brushed motor. The gimbal can be arranged at the top or bottom of the UAV 1200.

The image collection device 1204, for example, can be an apparatus configured to capture an image, such as a camera, a recorder, or an infrared thermal imager. The image collection device 1204 can communicate with the flight controller 1202a and photograph under the control of the flight controller 1202a. In some embodiments, the image collection device 1204 can include at least a photosensitive element. The photosensitive element can be a complementary metal-oxide-semiconductor (CMOS) sensor or a charge-coupled device (CCD) sensor. For example, a camera device can be configured to capture an image or a series of images with a specific image resolution. In some embodiments, the camera device can be configured to capture a series of images with a specific capture rate. In some embodiments, the camera device can include a plurality of adjustable parameters. The camera device can be configured to capture different images with different parameters under the same external condition (e.g., position and lighting). The image collection device 1204 can be directly fixed at the UAV 1200. Then, the gimbal 1203 can be saved. The image collected by the image collection device 1204 can be sent to the processor (not shown in the figure) for processing. The processed image or the information extracted from the image through the processing can be sent to the terminal apparatus 1300 and the display apparatus 1400. The processor can be carried by the UAV 1200 or arranged at the ground terminal. The processor can communicate with the UAV 1200 wirelessly.

The display apparatus 1400 can be arranged at the ground terminal, can communicate wirelessly with the UAV 1200, and can be configured to display the attitude information of the UAV 1200. In addition, images collected by the image collection device 1204 can be displayed on the display apparatus 1400. The display apparatus 1400 can be an independent apparatus or integrated into the terminal apparatus 1300.

The terminal apparatus 1300 can be arranged at the ground terminal, communicate wirelessly with the UAV 1200, and be configured to remotely control the UAV 1200.

The naming of the components of the unmanned flight system above is for identification purposes only and should not be understood as limitations of embodiments of the present disclosure.

This disclosure further provides a computer-readable storage medium storing a computer program. When the program is executed by the processor, the processor can be caused to perform the processes performed by the second processing unit in the method of embodiments of the present disclosure.

The computer-readable medium can include permanent and non-permanent, movable and non-movable media and can store the information in any method or technology. The information can include a computer-readable instruction, a data structure, a program module, or other data. In some embodiments, the computer-readable storage medium can include but is not limited to a phase-change memory (PRAM), a static random-access memory (SRAM), a dynamic random-access memory (DRAM), another type of random-access memory (RAM), a read-only memory (ROM), an electrically erasable programmable read-only memory (EEPROM), a flash memory, or another memory technology, CD-ROM, a digital versatile disc (DVD), or another optical storage, a magnetic tape cassette, a magnetic disk storage, or another magnetic storage device, or any other non-transitory medium that can be used to store information accessible by a computing apparatus. The computer-readable medium may not include a transitory computer-readable medium, such as a modulated data signal and a carrier.

From the description above, those skilled in the art can understand that embodiments of the present disclosure can be implemented by software with a necessary general hardware platform. Based on this understanding, the essence or the part contributing to the existing technology of the technical solution of embodiments of the present disclosure can be embodied in the form of a software product. The software product can be stored in a storage medium such as ROM/RAM, a disk, or a CD-ROM, and include several instructions used to cause a computer (e.g., a personal computer, a server, or a network apparatus) to execute an embodiment of the present disclosure or the methods of certain parts of embodiments of the present disclosure.

The system, device, module, or unit described in embodiments of the present disclosure can be specifically implemented by a computer chip or entity, or by a product with a certain function. A typical implementation apparatus can be a computer. The computer can include a personal computer, a laptop computer, a cellular phone, a camera phone, a smartphone, a personal digital assistant, a media player, a navigation device, an email receiving and sending apparatus, a game console, a tablet computer, a wearable apparatus, or a combination thereof.

The technical features of embodiments of the present disclosure can be combined arbitrarily, as long as the combinations of the features do not conflict or contradict each other, which are not described one by one. The arbitrary combinations of the technical features can be also within the scope of the present disclosure.

After considering the description and practicing of the present disclosure, those skilled in the art can easily think of other embodiments of the present disclosure. The present disclosure is intended to cover any variations, uses, or adaptive changes of the present disclosure. The variations, uses, or adaptive changes follow general principles and include common knowledge or common technical means in the art. The specification and embodiments of the present disclosure are exemplary. The scope of the present disclosure is subject to the appended claims.

The present disclosure is not limited to the precise structure described above. Various modifications and changes can be made without departing from the scope of the present disclosure. The scope of the present disclosure is subject to the appended claims.

The above are some embodiments of the present disclosure and do not limit the present disclosure. Any modifications, equivalent replacements, and improvements within the spirit and principle of the present disclosure are within the scope of the present disclosure.

What is claimed is:

1. A control method comprising:
obtaining a thermal image of a fire area through an aerial vehicle;
obtaining a temperature distribution of the fire area based on the thermal image;
dividing the fire area into a plurality of sub-areas based on the temperature distribution of the fire area, the plurality of sub-areas having different fire levels; and
projecting the plurality of sub-areas on a map including the fire area and displayed by a control terminal.

2. The method according to claim 1, wherein:
each of the plurality of sub-areas corresponds to a temperature distribution range; and/or
projection areas of different ones of the plurality of sub-areas on the map correspond to different image features.

3. The method according to claim 2, wherein the image features include at least one of colors of the projection areas, transparency, filling patterns, line types of boundaries of the projection areas, or line colors of the boundaries of the projection areas.

4. The method according to claim 1, wherein:
the fire levels include at least no-fire, burning, and burned-out; and
the plurality of sub-areas include a no-fire area, a burning area, and a burned-out area.

5. The method according to claim 4, wherein dividing the fire area into the plurality of sub-areas based on the temperature distribution of the fire area includes:
determining a boundary between the burning area and the no-fire area through a first positioning strategy; and
determining a boundary between the burned-out area and the burning area through a second positioning strategy, a positioning precision of the first positioning strategy being higher than a positioning precision of the second positioning strategy.

6. The method according to claim 1, further comprising:
obtaining position information of a fire line of the fire area in real-time;
projecting the image of the fire area onto the map based on the position information of the fire line to display a position of the fire area on the map, the map including position information of a target area; and
determining a distance between the fire area and the target area based on the position of the fire area and the position information of the target area.

7. The method according to claim 6, wherein the target area includes at least one of a school, a gas station, a hospital, a power station, a chemical plant, or an area with a population density greater than a preset value.

8. The method according to claim 6, further comprising:
obtaining moving speed information of the fire line; and
predicting a time for the fire line to move to the target area based on the distance between the fire area and the target area and the moving speed information of the fire line.

9. The method according to claim 8, further comprising:
determining a risk level of the target area based on any one of:
the time for the fire line to move to the target area;
the time for the fire line to move to the target area and a type of the target area; or
the time for the fire line to move to the target area and a moving speed and a moving direction of a target gas in the fire area.

10. The method according to claim 9, further comprising:
broadcasting alarm information to the target area with the risk level greater than a preset value.

11. The method according to claim 10, wherein the alarm information includes information on an evacuation route from the target area to a safe area or address information of the safe area.

12. The method according to claim 10, wherein the alarm information is determined based on at least one of the position of the target area, the position of the fire area, the moving speed of the fire line, or the moving direction of the fire line.

13. The method according to claim 1, further comprising:
obtaining one or more RGB images of the fire area; and
detecting position information of the fire line from the one or more RGB images.

14. The method according to claim 13, wherein detecting the position information of the fire line from the one or more RGB images includes:
determining depth information of a pixel of the fire line based on the one or more RGB images captured by the aerial vehicle in one or more different poses; and
determining position information of the pixel of the fire line based on one or more attitudes of an image collection device capturing the one or more RGB images, one or more poses of the aerial vehicle when capturing the one or more RGB images, and the depth information of the pixel of the fire line.

15. The method according to claim 1, further comprising:
obtaining position information of the fire area;
determining a dangerous area around the fire area based on the position information of the fire area, a distance between the dangerous area and the fire area being smaller than a preset distance threshold; and
controlling power of the dangerous area to be disconnected.

16. The method according to claim 1, further comprising:
obtaining a first image before fire starts in the fire area;
after the fire starts, controlling the aerial vehicle to capture a second image of the fire area; and
fusing the first image and the second image to obtain a fusion image.

17. The method according to claim 1, further comprising:
obtaining an RGB image of the fire area and an early-warning map of the fire area, the early-warning map being configured to represent risk levels of target areas around the fire area; and
displaying the RGB image and the early-warning map, the early-warning map being displayed at a predetermined position of the RGB image.

18. The method according to claim 1, further comprising:
obtaining position information and environment information of the fire area; and
sending the position information and the environment information of the fire area to a rescue aerial vehicle.

19. The method according to claim 1, further comprising:
searching for a living body in the fire area based on the thermal image of the fire area;
in response to the living body being found, obtaining position information of the live body; and
sending the position information to a target device.

20. A control device comprising a processor configured to:
obtain a thermal image of a fire area through an aerial vehicle;
obtain a temperature distribution of the fire area based on the thermal image;
divide the fire area into a plurality of sub-areas based on the temperature distribution of the fire area, the plurality of sub-areas having different fire levels; and
project the plurality of sub-areas on a map including the fire area displayed by a control terminal.
